(19) United States
(12) Patent Application Publication
(10) Pub. No.: US 2010/0304967 A1
(43) Pub. Date: Dec. 2, 2010

(54) METHOD OF PROTECTING RICE CROPS

(75) Inventor: Georg Rudiger Kotzian, Basel (CH)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA CROP PROTECTION, INC., Greensboro, NC (US)

(21) Appl. No.: 12/740,236

(22) PCT Filed: Oct. 31, 2008
(86) PCT No.: PCT/EP2008/009210

§ 371 Date: Apr. 28, 2010

(30) Foreign Application Priority Data
Nov. 1, 2007 (CH) 1697/07

(51) Int. Cl. A01N 25/32

(52) U.S. Cl. 504/105; 504/110

(57) ABSTRACT

A method of protecting rice crops from the phytotoxic action of herbicides by dressing the seed material with a compound of formula (I) or (II).

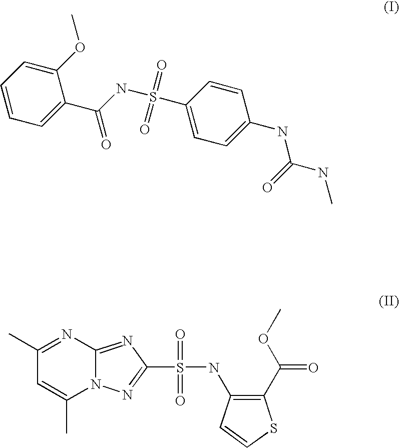

The present invention relates to a novel method of protecting rice crops from the phytotoxic action of herbicides.

The use of herbicides can—for example depending on the concentration of the herbicide and the mode of its application, the plant being cultivated, the nature of the soil, and the climatic conditions such as period of exposure to light, temperature and amounts of precipitation—result in considerable damage also being caused to the cultivated plants. In order to counter such problems, various substances have already been proposed as safeners that are capable of protecting the cultivated plant from the damaging action of the herbicide, while the herbicidal action on the undesirable grasses and weeds to be controlled is virtually unimpaired. It has been found that the proposed safeners often have a very specific action both in respect of the cultivated plants and in respect of the herbicide and in some cases also in dependence upon the mode of application. This means that a particular safener is often suitable only for a particular cultivated plant and a specific class of herbicide or even just a particular herbicide. For example, U.S. Pat. No. 5,102,445 discloses compounds which protect cultivated plants such as rice from the phytotoxic action of herbicides from the class of aryloxyphenoxypropionic acid derivatives.

It has now been found that the compounds

of formula I

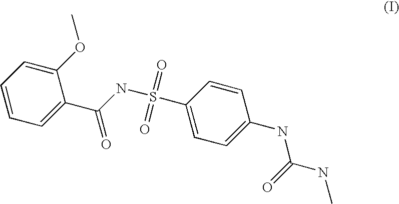

and of formula II

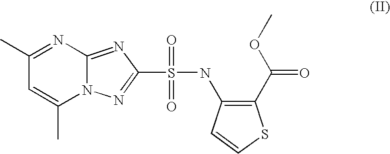

are also suitable as safeners for protecting directly sown rice from the phytotoxic action of certain herbicides if the seed material is dressed with those safeners.

There is accordingly proposed, in accordance with the invention, a novel method of protecting directly sown rice crops from the phytotoxic action of herbicides selected from the group propaquizafop, quizalofop, haloxyfop, fluazifop, diclofop, fenoxaprop, clodinafop and pinoxaden, which method comprises
(1) dressing the rice seed material with an amount, effective for herbicide antagonism, of a safener selected from the group of compounds of formula I

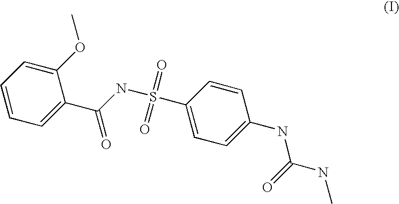

and formula II

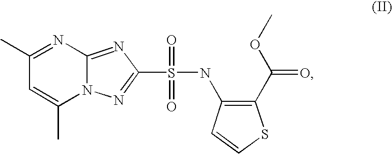

(2) sowing the seed material dressed with the safener and then
(3) applying a herbicidally effective amount of a herbicide selected from the group propaquizafop, quizalofop, haloxyfop, fluazifop, diclofop, fenoxaprop, clodinafop and pinoxaden or of a mixture thereof.

The mentioned herbicides are known and, for example, described in The Pesticide Manual, Twelfth Edition, BCPC, 2000.

The safener of formula I is known, for example from EP-A-0 365 484. The safener of formula II is, for example, described in EP-A-0 378 508.

Rice crops are understood as being Oryza sativa, which also includes rice that has become wild or degenerated, and also crops thereof which have been rendered tolerant to herbicides or classes of herbicides (e.g. ALS-, GS-, EPSPS-, PPO- and HPPD-inhibitors), such as, for example, to imidazolinones such as imazamox (Clearfield Rice) by conventional methods of breeding or by genetic engineering.

Examples of weeds that can be controlled in accordance with the invention, besides rice that has become wild or degenerated, are grasses such as, especially, Echinochloa and Leptochloa.

An unacceptable level of damage can be caused to rice crops if the safener, for example cloquintocet, is applied together with the herbicide, for example in a spray mixture. Surprisingly, however, that damage can be avoided if the seed material has been dressed with the safener beforehand and the herbicide is not applied until after the dressed seed material has been planted. This moreover also avoids the safening action being extended to wild rice as a result of which it would no longer be possible for the wild rice to be controlled. In addition, this avoids undesirable grasses such as Echinochloa and Leptochloa being subject to safening as may occur in the case of joint tank application.

It is of great importance that, using the method according to the invention, it is possible successfully to control rice that has become wild or degenerated, as such rice constitutes an ever greater problem in crops of directly sown rice. If the rice seed grains were not dressed with the safeners of formula I or II, the herbicides used according to the invention would, at the customary application rates of about 60 g/ha or more, cause up to 80% damage in rice crops.

The present invention accordingly further relates to a method of selectively controlling wild rice in crops of directly sown rice, which method comprises
(1) dressing the rice seed material with an amount, effective for herbicide antagonism, of a safener selected from the group of compounds of formula I

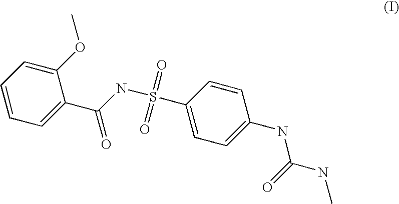

and formula II

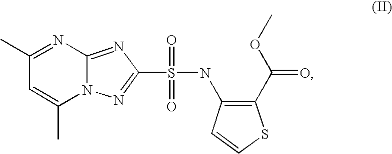

(2) sowing the seed material dressed with the safener and then
(3) applying a herbicidally effective amount of a herbicide selected from the group propaquizafop, quizalofop, haloxyfop, fluazifop, diclofop, fenoxaprop, clodinafop and pinoxaden or of a mixture thereof.

Dressing the rice seed material can be carried out in customary manner:
a) Dressing the seeds with a wettable powder formulation of safener of formula I or II by shaking in a vessel until the formulation is uniformly distributed over the seed surface (dry dressing). In that case, about from 1 to 500 g of safener of formula I or II (from 4 g to 2 kg of wettable powder) is used per 100 kg of seed material.
b) Dressing the seeds with an emulsifiable concentrate of safener of formula I or II according to method a) (wet dressing).
c) Dressing by immersing the seed material in a liquid formulation comprising from 100 to 1000 ppm of safener of formula I or II for from 1 to 72 hours and, if desired, subsequently drying the seeds (immersion dressing).

Generally from 1 to 1000 g, preferably from 1 to 500 g, and especially from 1 to 200 g, of safener is used per 100 kg of seed material, but depending on the methodology, which also allows other active ingredients or micronutrients to be added, concentrations above or below the limits indicated may be employed (repeat dressing).

The herbicidally effective amount of the herbicides used in accordance with the invention may be formulated in customary manner together with formulation adjuvants such as carriers, solvents and surface-active substances. The formulations may be in various physical forms, for example in the form of dusting powders, gels, wettable powders, water-dispersible granules, water-dispersible tablets, effervescent tablet compacts, emulsifiable concentrates, micro-emulsifiable concentrates, oil-in-water emulsions, oil flowables, aqueous dispersions, dispersions in oil, suspoemulsions, capsule suspensions, emulsifiable granules, soluble liquids, water-soluble concentrates (having water or a water-miscible organic solvent as carrier), impregnated polymer films, or in other forms that are known, for example from the Manual on Development and Use of FAO Specifications for Plant Protection Products, 5th Edition, 1999. Those formulations either can be used directly or are diluted before use. The dilutions can be produced using, for example, water, liquid fertilisers, micronutrients, biological organisms, oil or solvents.

The formulations can be produced, for example, by mixing the active ingredient with formulation adjuvants to obtain compositions in the form of finely divided solids, granules, solutions, dispersions or emulsions. The active ingredients can also be formulated with other adjuvants such as finely divided solids, mineral oils, oils of vegetable or animal origin, modified oils of vegetable or animal origin, organic solvents, water, surface-active substances or combinations thereof. The active ingredients can also be contained in very fine microcapsules consisting of a polymer. Microcapsules contain the active ingredients in a porous carrier. This enables active ingredients to be released into the surroundings in controlled amounts (e.g. slow release). Microcapsules usually have a diameter of from 0.1 to 500 microns. They contain active ingredients in an amount of about from 25 to 95° A) by weight of the capsule weight. The active ingredients can be present in the form of a monolithic solid, in the form of fine particles in solid or liquid dispersion or in the form of a suitable solution. The encapsulating membranes comprise, for example, natural and synthetic gums, cellulose, styrene-butadiene copolymers, polyacrylonitrile, polyacrylate, polyester, polyamides, polyureas, polyurethane or chemically modified polymers and starch xanthates or other polymers known in this context to the person skilled in the art. Alternatively, it is possible for very fine microcapsules to be formed wherein the active ingredient is present in the form of finely divided particles in a solid matrix of a base substance, but in that case the microcapsules are not surrounded by a casing.

The formulation adjuvants that are suitable for producing the compositions according to the invention are known per se. As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethylene glycol, ethyl lactate, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol (PEG400), propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weights such as amyl alcohol, tetrahydrofurfuryl alcohol, hexanol, octanol, ethylene glycol, propylene glycol, glycerol, N-methyl-2-pyrrolidone, and the like. Water is generally the carrier of choice for dilution of the concentrates. Suitable solid carriers are, for example, talc, titanium dioxide, pyrophyllite clay, silica, attapulgite clay, kieselguhr, chalk, calcium carbonate, bentonite, calcium montmorillonite, cottonseed husks, wheat flour, soybean flour, pumice, wood flour, ground walnut shells, lignin and similar substances such as are described, for example, in CFR 180.1001. (c) & (d).

A large number of surface-active substances can advantageously be used both in solid and in liquid formulations, especially in those which can be diluted with a carrier before application. Surface-active substances can be anionic, cationic, non-ionic or polymeric, and they can be used as emulsifying agents, wetting agents or suspension agents or for other purposes. Typical surface-active substances include, for example, salts of alkyl sulfates, e.g. diethanolammonium lauryl sulfate; salts of alkylarylsulfonates, e.g. calcium dodecylbenzene-sulfonate; addition products of alkylphenols and alkylene oxides, e.g. nonylphenol ethoxylates; addition products of alcohols and alkylene oxides, e.g. tridecylalcohol ethoxylates; soaps, e.g. sodium stearate; salts of alkylnaphthalenesulfonates, e.g. sodium dibutylnaphthalenesulfonate; dialkyl esters of sulfosuccinate salts, e.g. sodium di(2-ethyl-hexyl)sulfosuccinate; sorbitol esters, e.g. sorbitol oleate; quaternary amines, e.g. lauryl trimethylammonium chloride, polyethylene glycol esters of fatty acids, e.g. polyethylene glycol stearate; block copolymers of ethylene oxide and propylene oxide; and salts of mono- and di-alkyl phosphate esters; and also further substances described, for example, in McCutcheon's Detergents and Emulsifiers Annual, MC Publishing Corp., Ridgewood N.J., 1981.

Further adjuvants which can usually be used in pesticidal formulations include crystallisation inhibitors, viscosity-modifying substances, suspension agents, dyes, antioxidants, foaming agents, light-absorbing agents, mixing adjuvants, anti-foams, complex-formers, neutralising or pH-modifying substances and buffers, corrosion inhibitors, fragrances, wetting agents, take-up enhancers, micronutrients, plasticisers, glidants, lubricants, dispersants, thickening agents, antifreeze agents, microbicidal agents, and also liquid and solid fertilisers.

The formulations may also comprise additional active substances, e.g. further herbicides, plant growth regulators, fungicides or insecticides.

The compositions according to the invention may additionally include an additive comprising an oil of vegetable or animal origin, a mineral oil, alkyl esters of such oils or mixtures of such oils and oil derivatives. The amounts of oil additive used in the composition according to the invention are generally from 0.01 to 10%, based on the spray mixture. For example, the oil additive can be added to the spray tank in the desired concentration after the spray mixture has been prepared. Preferred oil additives comprise mineral oils or an oil of vegetable origin, for example rapeseed oil, olive oil or sunflower oil, emulsified vegetable oil, such as AMIGO® (Rhône-Poulenc Canada Inc.), alkyl esters of oils of vegetable origin, for example the methyl derivatives, or an oil of animal origin, such as fish oil or beef tallow. A preferred additive contains as active components, for example, essentially 80% by weight alkyl esters of fish oils and 15% by weight methylated rapeseed oil, and also 5% by weight of customary emulsifiers and pH modifiers. Especially preferred oil additives comprise alkyl esters of C₈-C₂₂ fatty acids, with special importance being attached to the methyl derivatives of C₁₂-C₁₈ fatty acids, for example the methyl esters of lauric acid, palmitic acid and oleic acid. Those esters are known as methyl laurate (CAS-111-82-0), methyl palmitate (CAS-112-39-0) and methyl oleate (CAS-112-62-9). A preferred fatty acid methyl ester derivative is Emery® 2230 and 2231 (Cognis GmbH). These and other oil derivatives are also known from the Compendium of Herbicide Adjuvants, 5th Edition, Southern Illinois University, 2000.

The application and action of the oil additives can be further improved by combining them with surface-active substances, such as non-ionic, anionic or cationic surfactants. Examples of suitable anionic, non-ionic and cationic surfactants are listed on pages 7 and 8 of WO 97/34485. Preferred surface-active substances are anionic surfactants of the dodecylbenzylsulfonate type, especially the calcium salts thereof, and also non-ionic surfactants of the fatty alcohol ethoxylate type. Special preference is given to ethoxylated C₁₂-C₂₂ fatty alcohols having a degree of ethoxylation of from 5 to 40. Examples of commercially available surfactants are the Genapol types (Clariant AG). Also preferred are silicone surfactants, especially polyalkyl-oxide-modified heptamethyltrisiloxanes, which are commercially available, for example, as Silwet L-77®, and also perfluorinated surfactants. The concentration of surface-active substances in relation to the total additive is generally from 1 to 30% by weight. Examples of oil additives that consist of mixtures of oils or mineral oils or derivatives thereof with surfactants are Edenor ME SU®, Turbocharge® (Syngenta Agro, CH) and Actipron® (BP Oil UK Limited, GB).

Where appropriate, the mentioned surface-active substances can also be used alone, that is to say without oil additives, in the formulations.

The addition of an organic solvent to the oil additive/surfactant mixture can also bring about a further enhancement of action. Suitable solvents are, for example, Solvesso® (ESSO) and Aromatic Solvent® (Exxon Corporation). The concentration of such solvents can be from 10 to 80% by weight of the total weight. Such oil additives, which are present in admixture with solvents, are described, for example, in U.S. Pat. No. 4,834,908. A commercially available oil additive known therefrom is known by the name MERGE® (BASF Corporation). A further oil additive that is preferred according to the invention is SCORE® (Syngenta Crop Protection Canada).

In addition to the oil additives listed above, it is also possible, for the purpose of enhancing the action of the compositions according to the invention, to add formulations of alkylpyrrolidones (e.g. Agrimax®) to the spray mixture. Formulations of synthetic latices, such as, for example, polyacrylamide, polyvinyl compounds or poly-1-p-menthene (e.g. Bond®, Courier® or Emerald®), can also be used for the purpose. Solutions comprising propionic acid, for example Eurogkem Pen-e-trate®, can also be admixed with the spray mixture as action-enhancing agents.

The herbicide formulations generally contain from 0.1 to 99% by weight, especially from 0.1 to 95% by weight, of herbicide and from 1 to 99.9% by weight of a formulation adjuvant which preferably contains from 0 to 25% by weight of a surface-active substance. Whereas commercial products will preferably be usually formulated as concentrates, the end user will normally employ dilute formulations.

In the methods according to the invention preference is given to using clodinafop or pinoxaden as herbicides, with special preference being given to clodinafop. A preferred safener is the compound of formula I.

Preferred formulations have especially the following compositions:
(%=percent by weight herbicide)

### Emulsifiable Concentrates:

herbicide: 1 to 95%, preferably 5 to 90%
surface-active agent: 1 to 30%, preferably 5 to 20%
liquid carrier: 1 to 80%, preferably 1 to 35%

### Dusts:

herbicide: 0.1 to 10%, preferably 0.1 to 5%
solid carrier: 99.9 to 90%, preferably 99.9 to 99%

### Suspension Concentrates:

herbicide: 5 to 75%, preferably 10 to 50%
water: 94 to 24%, preferably 88 to 30%
surface-active agent: 1 to 40%, preferably 2 to 30° A

### Wettable Powders:

herbicide: 0.5 to 90%, preferably 1 to 80%
surface-active agent: 0.5 to 20%, preferably 1 to 15%
solid carrier: 5 to 95%, preferably 15 to 90%

### Granules:

herbicide: 0.1 to 30%, preferably 0.1 to 15%
solid carrier: 99.5 to 70%, preferably 97 to 85° A

The following Examples illustrate the invention further, but do not limit the invention.

### EXAMPLES OF FORMULATIONS FOR THE HERBICIDES

### %=PERCENT BY WEIGHT

| F1. Emulsifiable concentrates | a) | b) | c) | d) |
|---|---|---|---|---|
| herbicide | 5% | 10% | 25% | 60% |
| calcium dodecylbenzenesulfonate | 6% | 8% | 6% | 8% |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| NMP | — | — | 10% | 20% |
| arom. hydrocarbon mixture | 85% | 78% | 55% | 16% |
| C₉-C₁₂ | | | | |

Emulsions of any desired concentration can be obtained from such concentrates by dilution with water.

| F2. Solutions | a) | b) | c) | d) |
|---|---|---|---|---|
| herbicide | 5% | 10% | 50% | 90% |
| 1-methoxy-3-(3-methoxy- | — | 20% | 20% | — |
| propoxy)-propane | | | | |
| polyethylene glycol MW 400 | 20% | 10% | — | — |
| NMP | — | — | 30% | 10% |
| arom. hydrocarbon mixture | 75% | 60% | — | — |
| C₉-C₁₂ | | | | |

The solutions are suitable for use in the form of microdrops.

| F3. Wettable powders | a) | b) | c) | d) |
|---|---|---|---|---|
| herbicide | 5% | 25% | 50% | 80% |
| sodium lignosulfonate | 4% | — | 3% | — |
| sodium lauryl sulfate | 2% | 3% | — | 4% |
| sodium diisobutylnaphthalene- | — | 6% | 5% | 6% |
| sulfonate | | | | |
| octylphenol polyglycol ether | — | 1% | 2% | — |
| (7-8 mol of ethylene oxide) | | | | |
| highly dispersed silicic acid | 1% | 3% | 5% | 10% |
| kaolin | 88% | 62% | 35% | — |

The active ingredient is mixed thoroughly with the adjuvants and the mixture is thoroughly ground in a suitable mill, affording wettable powders which can be diluted with water to give suspensions of any desired concentration.

| F4. Coated granules | a) | b) | c) |
|---|---|---|---|
| herbicide | 0.1% | 5% | 15% |
| highly dispersed silicic acid | 0.9% | 2% | 2% |
| inorganic carrier | 99.0% | 93% | 83% |
| (diameter 0.1-1 mm) | | | |
| e.g. CaCO₃ or SiO₂ | | | |

The active ingredient is dissolved in methylene chloride and applied to the carrier by spraying, and the solvent is then evaporated off in vacuo.

| F5. Coated granules | a) | b) | c) |
|---|---|---|---|
| herbicide | 0.1% | 5% | 15% |
| polyethylene glycol MW 200 | 1.0% | 2% | 3% |
| highly dispersed silicic acid | 0.9% | 1% | 2% |
| inorganic carrier | 98.0% | 92% | 80% |
| (diameter 0.1-1 mm) | | | |
| e.g. CaCO₃ or SiO₂ | | | |

The finely ground active ingredient is uniformly applied, in a mixer, to the carrier moistened with polyethylene glycol. Non-dusty coated granules are obtained in this manner.

| F6. Extruder granules | a) | b) | c) | d) |
|---|---|---|---|---|
| herbicide | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed and ground with the adjuvants, and the mixture is moistened with water. The mixture is extruded and then dried in a stream of air.

| F7. Dusts | a) | b) | c) |
|---|---|---|---|
| herbicide | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

| F8. Suspension concentrates | a) | b) | c) | d) |
|---|---|---|---|---|
| herbicide | 3% | 10% | 25% | 50% |
| ethylene glycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde | 0.2% | 0.2% | 0.2% | 0.2% |
| solution | | | | |
| silicone oil emulsion | 0.8% | 0.8% | 0.8% | 0.8% |
| water | 87% | 79% | 62% | 38% |

The finely ground active ingredient is intimately mixed with the adjuvants, giving a suspension concentrate from which suspensions of any desired concentration can be obtained by dilution with water.

The ability of the safeners of formulae I and II to protect crops of rice from the phytotoxic action of the herbicides and to control wild rice in such crops is illustrated in the following Examples.

### BIOLOGICAL EXAMPLES

### Example 1

500 g of rice seed material are soaked in water in a plastic dish for 24 hours. After the water has been poured off, the seed material is allowed to dry in air for 1 to 2 hours; 0.025 or 0.25 g of safener of formula (I) or (II) is then added and vigorous shaking is carried out. Sowing is performed 24 hours later.

5 days after sowing, the herbicide clodinafop in the form of an EC 100 is applied at a rate of application of 60 g/ha. 5, 10 and 15 days afterwards, the damage to the rice plants that have emerged and to the weeds is determined. The results obtained are shown in Table 1.

TABLE 1

| | | Damage to rice (%) | | | Damage to |
|---|---|---|---|---|---|
| Safener per 500 g of | Clodinafop | after number of days | | | undesirable |
| seed material | (g/ha) | 5 | 10 | 15 | grasses* (%) |
| No safener | 60 | 68 | 65 | 30 | 93 |
| Formula II at 0.025 g | 60 | 21 | 9 | 0 | 98 |
| Formula II at 0.25 g | 60 | 5 | 3 | 0 | 99 |
| Formula I at 0.025 g | 60 | 5 | 0 | 0 | 100 |
| Formula I at 0.25 g | 60 | 4 | 3 | 0 | 98 |

*Undesirable grasses here are wild rice (Oryza sativa), Echinochloa crus-galli and Leptochloa chinensis

### Example 2

500 g of rice seed material are soaked in water in a plastic dish for 24 hours. After the water has been poured off, the seed material is allowed to dry in air for 1 to 2 hours; 0.025 or 0.25 g of safener of formula (I) or (II) is then added and vigorous shaking is carried out. Sowing is performed 24 hours later.

5 days after sowing, the herbicide clodinafop in the form of an EC 100 is applied at a rate of application of 60 or 120 g/ha. 5, 10 and 15 days afterwards, the damage to the rice plants that have emerged and to the weeds is determined. For comparison, untreated cultivated rice is tested under the same conditions as an indicator of the behaviour of wild rice. The result obtained is shown in Table 2.

TABLE 2

| | | Damage to rice (%) | | |
|---|---|---|---|---|
| | Clodinafop | after number of days | | |
| | (g/ha) | 5 | 10 | 15 |
| Cultivated rice with | 60 | 18 | 8 | 0 |
| 0.025 g of safener (II) | 120 | 23 | 15 | 8 |
| Cultivated rice with | 60 | 13 | 9 | 0 |
| 0.25 g of safener (II) | 120 | 25 | 16 | 5 |
| Cultivated rice without | 60 | 40 | 90 | 65 |
| safener* | 120 | 78 | 98 | 100 |

*used as an indicator for wild rice

What is claimed is:

1. A method of protecting directly sown rice crops from the phytotoxic action of herbicides selected from the group propaquizafop, quizalofop, haloxyfop, fluazifop, diclofop, fenoxaprop, clodinafop and pinoxaden, which method comprises
(1) dressing the rice seed material with an amount, effective for herbicide antagonism, of a safener selected from the group of compounds of formula I 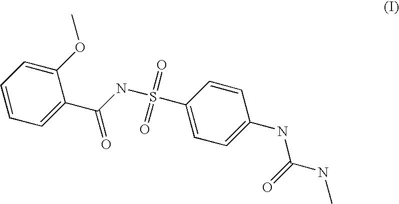
and formula II 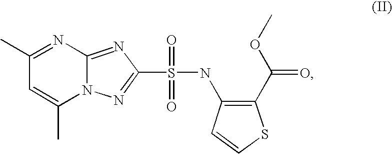
(2) sowing the seed material dressed with the safener and then
(3) applying a herbicidally effective amount of a herbicide selected from the group propaquizafop, quizalofop, haloxyfop, fluazifop, diclofop, fenoxaprop, clodinafop and pinoxaden or of a mixture thereof.

2. A method according to claim 1, which comprises applying the compound of formula I as safener.

3. A method according to claim 1, which comprises applying clodinafop or pinoxaden as herbicide.

4. A method according to claim 3, which comprises applying clodinafop as herbicide.

5. A method of selectively controlling wild rice in crops of directly sown rice, which method comprises
(1) dressing the rice seed material with an amount, effective for herbicide antagonism, of a safener selected from the group of compounds of formula I 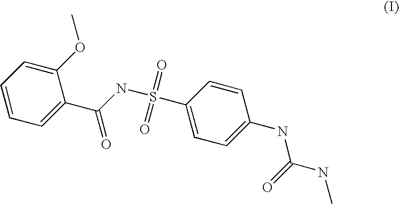
and formula II 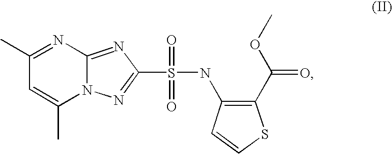
(2) sowing the seed material dressed with the safener and then
(3) applying a herbicidally effective amount of a herbicide selected from the group propaquizafop, quizalofop, haloxyfop, fluazifop, diclofop, fenoxaprop, clodinafop and pinoxaden or of a mixture thereof.

6. A method according to claim 5, which comprises applying the compound of formula I as safener.

7. A method according to claim 5, which comprises applying clodinafop or pinoxaden as herbicide.

8. A method according to claim 7, which comprises applying clodinafop as herbicide.
